(19) United States
(12) Patent Application Publication
(10) Pub. No.: US 2010/0213856 A1
(43) Pub. Date: Aug. 26, 2010

(54) POWER SUPPLY APPARATUS, METHOD FOR DRIVING POWER SUPPLY APPARATUS, LIGHT SOURCE APPARATUS EQUIPPED WITH POWER SUPPLY APPARATUS, AND ELECTRONIC APPARATUS

(75) Inventor: Kazuhisa MIZUSAKO, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/706,293

(22) Filed: Feb. 16, 2010

(30) Foreign Application Priority Data
Feb. 24, 2009 (JP) 2009-040322

(51) Int. Cl. H05B 37/02; G05F 1/00

(52) U.S. Cl. 315/158; 323/283; 315/291

(57) ABSTRACT

A power supply apparatus includes an AC/DC circuit, a DC/DC converter, a detection circuit, a digital IC, and a gate driver, and the like. A control formula used for phase compensation for each of a plurality of drive frequencies is stored in a memory of the digital IC. The power supply apparatus makes it possible to obtain a target voltage quickly by performing driving operation with a driving signal having a higher drive frequency at the time of activation. In addition, the power supply apparatus makes it possible to increase circuit efficiency by switching over from the driving signal having the higher drive frequency to a driving signal having a lower drive frequency upon reaching the target voltage.

### BACKGROUND

1. Technical Field

The present invention relates to a power supply apparatus, a method for driving the power supply apparatus, a light source apparatus that is equipped with the power supply apparatus, and an electronic apparatus.

2. Related Art

A switching-type power supply apparatus that includes analog elements and performs pulse width modulation is disclosed in JP-A-7-15952. The power supply apparatus disclosed in the above patent document is provided with a feedback (FB) circuit that is an analog circuit. The analog FB circuit detects a change in an output voltage and performs feedback control. The feedback control is performed in such a way as to ensure that the output voltage is kept substantially constant at a target voltage value on the basis of the result of detection. In addition, it is described in the above patent document that the power supply apparatus is used as a power source for a discharge lamp. Generally, in the field of a power supply apparatus that is used as a power source for a load device whose power consumption at the time of the initiation of lighting-up operation is different from power consumption during lighting operation, that is, a load device whose load changes or fluctuates, there is a demand for good tracking ability for responding to a load change. An example of a load device having such power consumption characteristics (i.e., load variation characteristics) is a discharge lamp. Good tracking ability for raising an output voltage to a target voltage value speedily is demanded not only for a discharge lamp but also for various kinds of solid-state light sources that are required to be capable of lighting up quickly, for example, a laser light source.

FIG. 12 is a graph that shows an example of curves representing tracking ability for responding to a load change. FIG. 13 is a graph that shows an example of a relationship between drive frequency and circuit efficiency. It is conceivable to change a switching drive frequency as a means for achieving good tracking ability in a switching-type power supply apparatus. The horizontal axis of FIG. 12 represents time. The vertical axis of FIG. 12 represents output voltage. The graph shows changes in the level of an output voltage when a laser light source is turned ON at a point in time t1. For example, in a case where a drive frequency f1 is used for switching, the level of a voltage reaches a target voltage value αV (i.e., the voltage level αV of a target voltage) at a point in time t3 as shown by a broken-line curve 62. In a case where a drive frequency f2, which is higher than the drive frequency f1, is used for switching, the level of a voltage reaches the target voltage value αV at a point in time t2 as shown by a solid-line curve 61. The point in time t2 is earlier than the point in time t3. That is, it is possible to enhance tracking ability by increasing a drive frequency. With the enhanced tracking ability, a laser light source can light up quickly.

However, circuit efficiency decreases as a drive frequency increases. The horizontal axis of FIG. 13 represents drive frequency. The vertical axis of FIG. 13 represents circuit efficiency. The circuit efficiency is η2 when the drive frequency f1 is used for switching. The circuit efficiency is η1 when the drive frequency f2 is used for switching. As understood from the graph, the circuit efficiency η1 corresponding to the drive frequency f2 is lower than the circuit efficiency η2 corresponding to the drive frequency f1. The decrease in circuit efficiency is attributable to switching loss in switching elements of a switching circuit (i.e., chopper circuit). The switching loss increases as the drive frequency becomes higher, which causes the decrease in circuit efficiency.

The power supply apparatus of related art that is provided with the analog FB circuit as disclosed in JP-A-7-15952 has a problem of circuit oscillation, which occurs when a drive frequency is changed. That is, there is a problem in that it is practically impossible or difficult to change a drive frequency. FIG. 14 is a circuit diagram that schematically illustrates an example of the circuit configuration of a power supply apparatus of related art. A power supply apparatus of related art 140 includes an AC/DC circuit 5, a DC/DC converter 1, a detection circuit 2, a feedback (FB) circuit 3, and an inverter 4 as main components. The AC/DC circuit 5 is a rectification circuit such as a bridge circuit or the like. The AC/DC circuit 5 converts an alternating voltage (i.e., AC voltage) into a direct voltage (i.e., DC voltage) and outputs the converted voltage to the DC/DC converter 1. The DC/DC converter 1 is a chopper circuit that converts the DC voltage into a voltage whose level is controlled according to a target voltage value. The DC/DC converter 1 includes switching field effect transistors (FETs) 6 and 7, an inductor 8, a capacitor 9, and the like. A load 10 is connected to each of two terminals of the capacitor 9. One terminal thereof is connected to the detection circuit 2. The detection circuit 2 is made up of two resistors 21 and 22 that are connected in series. Accordingly, the serial pair of resistors 21 and 22 is connected to the above one terminal. An output line for a detection voltage Vo that is tapped from a connection point of the two resistors 21 and 22 for division of a load voltage is connected to the FB circuit 3. The FB circuit 3 includes a phase compensation circuit 11, operational amplifiers 12 and 13, a reference voltage generation circuit 14, a triangular wave generation circuit 15, and the like.

The detection voltage Vo is inputted from the detection circuit 2 to a negative input terminal (i.e., minus terminal) of the operational amplifier 13. A reference voltage Vref is inputted from the reference voltage generation circuit 14 to a positive input terminal (i.e., plus terminal) of the operational amplifier 13. The phase compensation circuit 11 is connected between the negative input terminal of the operational amplifier 13 and an output terminal of the operational amplifier 13. With these circuits, an output voltage Vf that reflects a deviation obtained as a result of comparison of the detection voltage Vo that is proportional to the output voltage of the DC/DC converter 1 with the reference voltage Vref is outputted from the operational amplifier 13. The output voltage Vf is inputted to a negative input terminal of the operational amplifier 12. A triangular wave Vt is inputted from the triangular wave generation circuit 15 to a positive input terminal of the operational amplifier 12. A pulse wave is outputted from an output terminal of the operational amplifier 12. The pulse wave outputted from the operational amplifier 12 is inputted to a gate terminal of the FET 6 and an input terminal of the inverter 4. An output terminal of the inverter 4 is connected to a gate terminal of the FET 7. Accordingly, the FET 7 is set in an OFF state when the FET 6 is set in an ON state. The FET 6 is set OFF when the FET 7 is set ON. As explained above, the output voltage of the DC/DC converter 1 is compared with the reference voltage Vref. Pulse width modulation (PWM) control is performed with reflection of a deviation obtained as a result of comparison.

The phase compensation circuit 11 is made up of a resistor 11a and a capacitor 11b. The circuit constant of these circuit components is set at a constant for negative-feedback control in accordance with the transfer function of the circuit. That is, a specific drive frequency is taken as a precondition when the resistor 11a and the capacitor 11b are selected. For this reason, circuit stability decreases when the drive frequency is changed, resulting in the oscillation of the circuit, which is a problem that remains to be solved. In other words, since the phase compensation circuit 11 is a dedicated circuit whose multiplier factor has been set for driving the power supply apparatus 140 at a specific drive frequency, operation is not stable when it is off the specific drive frequency, that is, when driven at any frequency other than the specific drive frequency. Thus, it is practically impossible or difficult to change the drive frequency. In addition, even assuming that it were possible to change the driving frequency in the configuration of a power supply apparatus of related art, as explained earlier, circuit efficiency would decrease as tracking ability improves. To put it the other way around, tracking ability must be compromised for greater circuit efficiency, which is another problem that remains to be solved. In other words, in related art, it is difficult to achieve excellent tracking ability and great circuit efficiency, which have a trade-off relationship therebetween, in a compatible manner, thereby having it both ways.

### SUMMARY

In order to address the above-identified problems without any limitation thereto, the invention provides, as various aspects thereof, a power supply apparatus, a method for driving the power supply apparatus, a light source apparatus that is equipped with the power supply apparatus, and an electronic apparatus having the following novel and inventive features.

### APPLICATION EXAMPLES

### Some Aspects of the Invention

A power supply apparatus includes a direct current power source; a chopper circuit into which a voltage outputted from the direct current power source is inputted; a detection circuit that detects a value of a voltage corresponds to an output voltage value of the chopper circuit, which is hereinafter referred to as output voltage value; and a digital signal processor that generates a driving signal that is used for driving the chopper circuit, the digital signal processor including a storing section that stores a target voltage value, a control formula that is used for generating the driving signal, and a plurality of sets of coefficients, and an arithmetic operating section that calculates a deviation of the output voltage value from the target voltage value, wherein each of the plurality of sets of coefficients corresponds to one of a plurality of frequencies that are different from each other or one another, the digital signal processor determines a drive frequency of the driving signal on the basis of the deviation, and the digital signal processor inputs a set of coefficients that corresponds to the drive frequency selectively among the plurality of sets of coefficients to generate the driving signal.

In the operation of the above power supply apparatus, the digital signal processor generates a plurality of driving signals whose drive frequencies are different from each other or one another. Driving operation is performed by means of the plurality of driving signals. The coefficients of a control formula used for generating a driving signal vary depending on a deviation. The deviation is an index value that indicates a load change state. Therefore, it is possible to achieve both excellent tracking ability and great circuit efficiency in a compatible manner by adjusting the coefficients of the control formula in accordance with the variation of the deviation. That is, the power supply apparatus changes the coefficients of the control formula to use a relatively high drive frequency when the deviation is large where the load change is large. The power supply apparatus changes the coefficients of the control formula to use a relatively low drive frequency when the deviation is small where the load change is small. In other words, it is possible to enhance tracking ability when the load change is large. In addition, it is possible to increase circuit efficiency when the load change is small. Therefore, the power supply apparatus makes it possible to achieve both excellent tracking ability and great circuit efficiency in a compatible manner. Moreover, since the power supply apparatus performs digital processing, a drive-frequency changeover can be achieved without causing circuit oscillation.

In the configuration of the above power supply apparatus, it is preferable that the chopper circuit should be driven by means of the driving signal that has a first drive frequency when the deviation is larger than a predetermined value; and the chopper circuit should be driven by means of the driving signal that has a second drive frequency, which is lower than the first drive frequency, when the deviation has become equal to or smaller than the predetermined value. It is preferable that the above power supply apparatus should further include a drive time cumulative counting section that counts elapsed time that is measured from a point in time at which operation of the direct current power source is started, wherein the chopper circuit is driven by means of the driving signal that has a first drive frequency upon the start of the operation of the direct current power source, and the chopper circuit is driven by means of the driving signal that has a second drive frequency, which is lower than the first drive frequency, after the elapsed time has reached a predetermined point in time.

A light source apparatus includes the above power supply apparatus and a solid-state light source that emits light, wherein the power supply apparatus controls a light ON/OFF state of the solid-state light source. It is preferable that the above light source apparatus should further include a light amount detecting section that detects the amount of light emitted by the solid-state light source as a current value; and a converting section that converts the current value, which indicates the amount of light, into a voltage value that corresponds to an output voltage value, wherein the arithmetic operating section calculates the deviation with the use of the converted voltage value.

An electronic apparatus includes the light source apparatus according to Claim 4; and a light modulating section that modulates light emitted by the light source apparatus into modulated light in accordance with an image signal.

In addition, a method for driving a power supply apparatus is provided. The power supply apparatus is provided with a chopper circuit into which a voltage outputted from a direct current power source is inputted, a detection circuit that detects a value of a voltage corresponds to an output voltage value of the chopper circuit (output voltage value), and a digital signal processor that generates a driving signal that is used for driving the chopper circuit, the digital signal processor including a storing section that stores a target voltage value, a control formula that is used for generating the driving signal, and a plurality of sets of coefficients, each set of which corresponds to one of a plurality of drive frequencies that are different from each other or one another. The driving method includes (a) detecting the output voltage value and calculating a deviation of the output voltage value from the target voltage value; (b) comparing the calculated deviation with a predetermined deviation; and (c) switching the driving signal from a current driving signal to another driving signal whose drive frequency is lower than that of the current driving signal when the calculated deviation is not larger than the predetermined deviation.

### BRIEF DESCRIPTION OF THE DRAWINGS

The invention will be described with reference to the accompanying drawings, wherein like numbers reference like elements.

FIG. 1 is a circuit block diagram that schematically illustrates an example of the configuration of a power supply apparatus according to a first embodiment of the invention.

FIG. 2 is a waveform diagram that schematically illustrates an example of a PWM waveform according to an exemplary embodiment of the invention.

FIG. 3 is a Bode plot diagram that schematically illustrates an example of the characteristics of a power supply apparatus of related art, which is shown for the purpose of comparison.

FIG. 4 is a Bode plot diagram that schematically illustrates an example of the characteristics of a power supply apparatus according to the first embodiment of the invention.

FIG. 5 is a flowchart that schematically illustrates an example of a driving method according to the first embodiment of the invention.

FIG. 6 is a graph that schematically illustrates a change in the level of an output voltage when a driving method of a comparative example is used and a change in the level of an output voltage when a driving method according to the first embodiment of the invention is used, which are compared over a time series.

FIG. 7 is a flowchart that schematically illustrates an example of a driving method used by a power supply apparatus according to a second embodiment of the invention.

FIG. 8 is a graph that schematically illustrates a change in the level of an output voltage when a driving method according to the second embodiment of the invention is used, which is shown over a time series.

FIG. 9 is a block diagram that schematically illustrates an example of the configuration of a first light source apparatus according to an exemplary embodiment of the invention.

FIG. 10 is a block diagram that schematically illustrates an example of the configuration of a second light source apparatus according to an exemplary embodiment of the invention.

FIG. 11 is a diagram that schematically illustrates an example of the configuration of a projector according to an exemplary embodiment of the invention, which is an example of various kinds of electronic apparatuses.

FIG. 12 is a graph that shows an example of curves representing tracking ability for responding to a load change.

FIG. 13 is a graph that shows an example of a relationship between drive frequency and circuit efficiency.

FIG. 14 is a circuit diagram that schematically illustrates an example of the circuit configuration of a power supply apparatus of related art.

### DESCRIPTION OF EXEMPLARY EMBODIMENTS

### First Embodiment

### Overall Explanation of Power Supply Apparatus

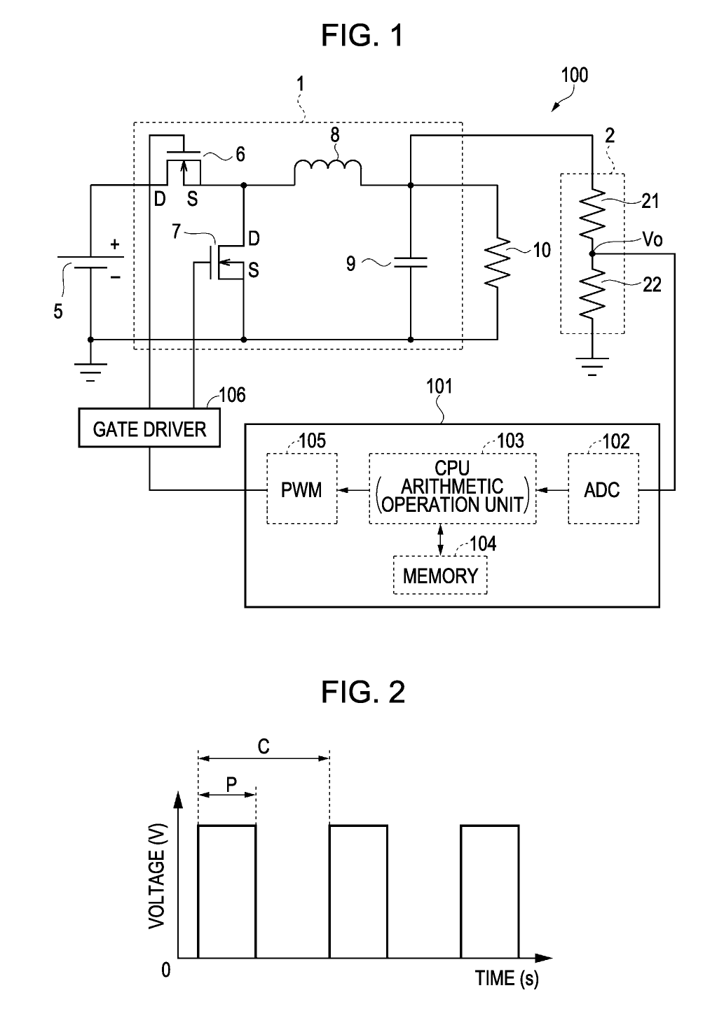

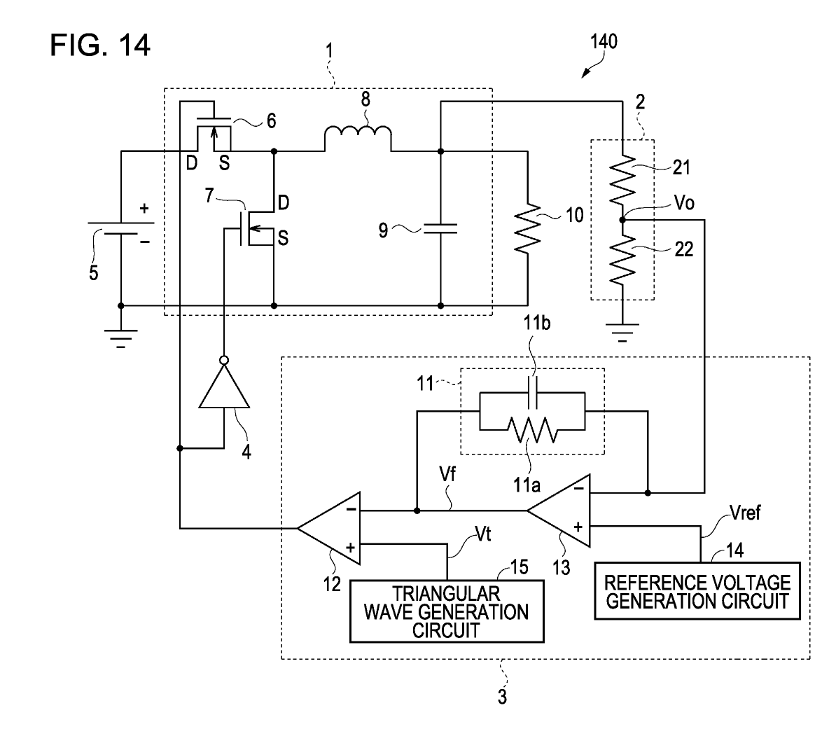

FIG. 1 is a circuit block diagram that schematically illustrates an example of the configuration of a power supply apparatus according to an exemplary embodiment of the invention. The overall configuration of a power supply apparatus 100 according to the present embodiment of the invention is explained below. In the following description of the configuration of the power supply apparatus 100, the same reference numerals are used for the same components as those of a power supply apparatus of related art illustrated in FIG. 14 so as to omit any redundant explanation or simplify explanation thereof. The power supply apparatus 100 is a digital power supply unit that includes an analog-to-digital (A/D) converter that performs digitization processing (i.e., discretization processing) on a detected output voltage, a digital feedback (FB) circuit that performs digital processing including arithmetic processing on digitized data, and the like. The power supply apparatus 100 has a feature of variable drive frequencies.

The power supply apparatus 100 includes an AC/DC circuit 5, a DC/DC converter 1, a detection circuit 2, a digital IC 101, and a gate driver 106 as main components. The AC/DC circuit 5 is an example of a direct current power source according to an aspect of the invention. In this embodiment, the AC/DC circuit 5, an example of the direct current power source, is a rectification circuit such as a bridge circuit or the like. The AC/DC circuit 5 converts an alternating voltage (i.e., AC voltage) into a direct voltage (i.e., DC voltage) and outputs the converted voltage to the DC/DC converter 1. The direct current power source is not limited to a rectification circuit. Any power source that can output a DC voltage can be adopted as the direct current power source. For example, it may be a battery. The DC/DC converter 1 is a chopper circuit. The DC/DC converter 1 drives its field effect transistors (FETs) 6 and 7 in a PWM driving scheme to convert an input voltage supplied from the AC/DC circuit 5 into a target voltage. The DC/DC converter 1 supplies a DC voltage after conversion to a load 10. The DC/DC converter 1 includes the FETs 6 and 7, an inductor 8, a capacitor 9, and the like. Each of the FETs 6 and 7 is an N-channel type metal oxide semiconductor (MOS) functioning as a switching element. A drain terminal of the FET 6 is connected to a positive terminal of the AC/DC circuit 5. A source terminal of the FET 6 is connected to one terminal of the inductor 8. The other terminal (output terminal) of the inductor 8 is connected to one terminal of the capacitor 9, one terminal of the load 10, and one terminal of the detection circuit 2. The other terminal of the capacitor 9 is connected to a negative terminal of the AC/DC circuit 5, the other terminal of the load 10, and a source terminal of the FET 7. A drain terminal of the FET 7 is connected to the source terminal of the FET 6 and the one terminal of the inductor 8.

The detection circuit 2 is made up of two resistors 21 and 22 that are connected in series. Accordingly, the serial pair of resistors 21 and 22 is connected to the one terminal of the capacitor 9. An output line for a detection voltage Vo that is tapped from a connection point of the two resistors 21 and 22 for division of a load voltage is connected to an A/D converter 102 of the digital IC 101. A terminal of the resistor 22 that is opposite a connection-point-side terminal is grounded. The voltage division ratio of the resistors 21 and 22 is predetermined according to the rating of the next processing block, that is, the rating of the A/D converter 102. Specifically, the voltage division ratio of the resistors 21 and 22 is set in such a way as to ensure that the level of the detection voltage Vo falls within the rated input range of the A/D converter 102.

The digital IC 101, which functions as a digital FB circuit, includes the A/D converter 102, a CPU 103, a memory 104, a PWM 105, and the like. The digital IC 101 is a digital signal processor. The CPU 103 is a central processing unit that controls each block in accordance with control program stored in the memory 104. Though not illustrated in the drawing, an oscillation circuit that includes an oscillation element such as a crystal oscillator is attached thereto. The CPU 103 including the oscillation circuit, the memory 104, and the like constitute a drive time cumulative count unit and an arithmetic operation unit, which will be explained later. The memory 104 is a nonvolatile memory such as a flash memory. Besides a target voltage value, a drive program that will be explained later, a control formula, a data table that contains parameters including constants of the control formula and sets of coefficients, and the like, are stored in the memory 140. The A/D converter 102 converts the analog detection voltage Vo that is proportional to the output voltage of the DC/DC converter 1 into digital data and then outputs the digital data to the CPU 103. The PWM 105 outputs a drive pulse for PWM control in accordance with the result of computation performed by the CPU 103 on the basis of a drive program and a control formula. For example, the PWM 105 outputs a drive pulse that switches over between a 3.3V voltage output state and a 0V state at predetermined time intervals in a variable repetition frequency. The digital IC 101 that includes the above components operates as follows. The A/D converter (ADC) 102 detects a voltage value. The CPU 103 reads the control formula out of the memory 104. The CPU 103 performs arithmetic operation with the use of the read control formula. Then, the PWM 105 outputs a pulse signal having a PWM waveform.

The gate driver 106 is provided with one input terminal and two output terminals. The PWM waveform pulse outputted from the digital IC 101 is inputted to the input terminal of the gate driver 106. One of the two output terminals of the gate driver 106 is connected to a gate terminal of the FET 6. The other output terminal is connected to a gate terminal of the FET 7. The gate driver 106 inverts the received PWM waveform and outputs the inverted waveform to the FET 7. On the other hand, the gate driver 106 outputs the received PWM waveform to the FET 6 without waveform inversion. By this means, the gate driver 106 drives the two FETs 6 and 7 alternately. That is, these FETs are put in an energized state in alternate shifts. If its driving capability is high enough, the inverter 4 (refer to FIG. 14) may be used as a substitute for the gate driver 106.

FIG. 2 is a waveform diagram that schematically illustrates an example of a PWM waveform according to an exemplary embodiment of the invention. The horizontal axis of FIG. 2 represents time (sec). The vertical axis of FIG. 2 represents voltage (V). The PWM waveform shown in FIG. 2 is an example of the waveform of a pulse signal supplied to the FET 6. For example, it is a rectangular wave whose one cycle c includes a 3.3V on-pulse application time period and a 0V time period. The term “PWM driving” means driving operation with duty control performed at a certain drive frequency. The term “duty value (or duty ratio)” means the ratio of an on-pulse application time period, which is a time period in which an ON pulse is applied, to one cycle c. In other words, let the length of the on-pulse time period be denoted as p; and the duty value can be expressed as p/c. An output voltage value changes as the duty value changes. Theoretically, an output voltage value is equal to an input voltage value multiplied by p/c [Output voltage value=(p/c)×Input voltage value]. However, the variation of the resistive load (i.e., load resistance) 10 affects an actual output voltage. In view of the effects of load variation, the power supply apparatus 100 performs voltage control as follows. The A/D converter 102 detects a voltage outputted from the DC/DC converter 1. The CPU 103 calculates a duty value of a PWM waveform. A driving signal that has the calculated duty value is used for driving the DC/DC converter 1. In this way, the output voltage of the AC/DC circuit 5 is converted into a target output voltage.

### Characteristics of Power Supply Apparatus

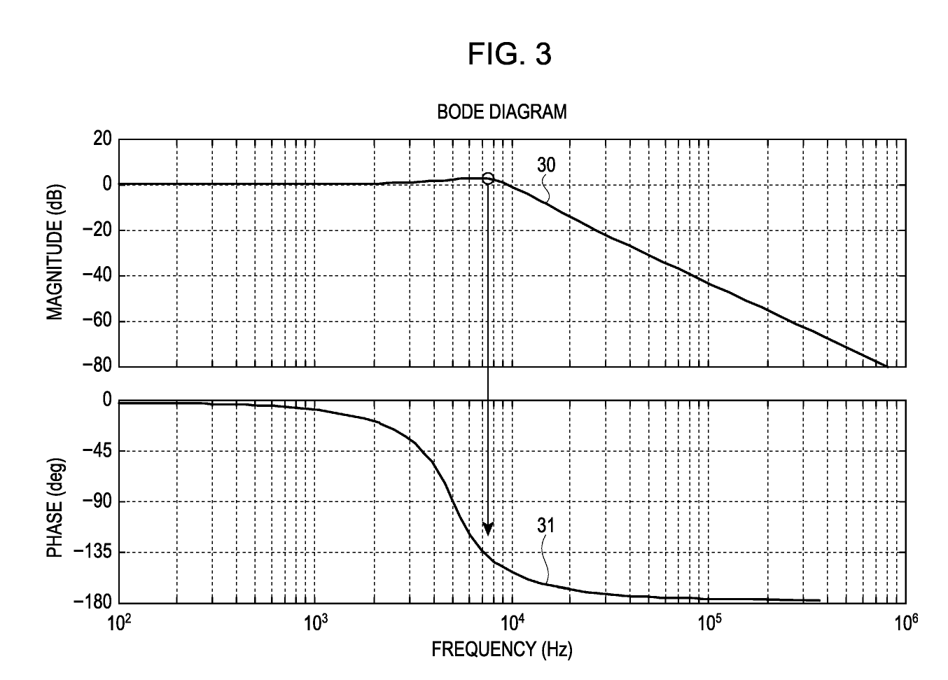

FIG. 3 is a Bode plot diagram that schematically illustrates an example of the characteristics of a power supply apparatus of related art. In the following description, the characteristics of the power supply apparatus 100 according to the present embodiment of the invention are compared with those of a power supply apparatus of related art. The characteristics of the related-art power supply apparatus 140 illustrated in FIG. 14 are explained first. FIG. 3 includes a Bode magnitude plot, which is a graph of gain versus frequency, and a Bode phase plot, which is a graph of phase versus frequency for the related-art power supply apparatus 140. The upper graph 30 shows the characteristics of gain (expressed on the vertical axis) versus frequency (expressed on the horizontal axis). The lower graph 31 shows the characteristics of phase (expressed on the vertical axis) versus frequency (expressed on the horizontal axis). In general, it is necessary to satisfy stability condition to perform feedback control for negative feedback. As the stability condition, it is necessary that phase should not be 180 degrees when gain is 1.0. In the characteristics of the related-art power supply apparatus 140, a phase shift of about 180 degrees occurs as indicated by an arrow in FIG. 3 when gain is 1.0 (shown by an open circle symbol). In other words, phase inversion occurs when a drive frequency changes. The reason why phase inversion occurs is that, as explained earlier, the phase compensation circuit 11 (refer to FIG. 14) is a dedicated circuit for a specific frequency. Accordingly, a power supply apparatus of related art has a problem of circuit oscillation.

In contrast, a digital power source (power supply apparatus 100) according to the present embodiment of the invention determines a duty value on the basis of a digital control formula. Therefore, it is possible to change the drive frequency without causing circuit oscillation. Specifically, phase delay and phase advance are controlled with the use of a control formula (formula (3)) in which integration elements and differentiation elements are considered. A more detailed explanation of the control formula will be given later.

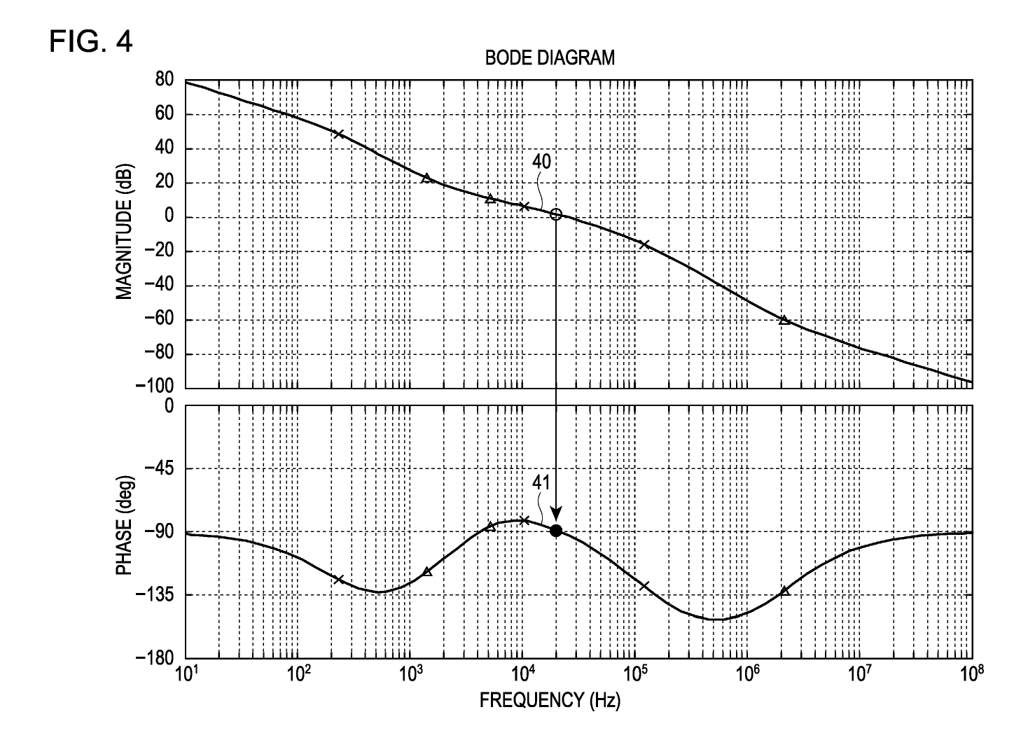

FIG. 4 is a Bode plot diagram that schematically illustrates an example of the characteristics of a power supply apparatus according to the present embodiment of the invention corresponding to those illustrated in FIG. 3. FIG. 4 shows a state in which the arrangement of integration elements (pole) and differentiation elements (zero) are optimized on the basis of a control formula. The control formula that is set in consideration of the transfer function of the DC/DC converter 1 (refer to FIG. 1) predetermines the arrangement of integration elements and differentiation elements. In the graph, an “x” symbol shows the differentiation element. A triangle symbol shows the integration element. When gain is 1.0 (shown by an open circle symbol) in the upper graph 40, phase is approximately minus 90 degrees as indicated by an arrow in the lower graph 41. This proves that stability condition is fully met. Thus, the circuit does not oscillate. A control formula for determining a phase-compensated duty value is important in order to satisfy the stability condition. The control formula is prepared on the basis of the transfer function of the DC/DC converter 1, the sampling time of the A/D converter 102, sets of coefficients determined according to PWM drive frequencies, and the like. The control formula is explained in detail below.

### Control Formula

The formula (1) shown below is a fundamental formula used for obtaining phase compensation illustrated in FIG. 4. The formula (1) is expressed in s domain. A term whose denominator is 0 represents an integration element. A term whose numerator is 0 represents a differentiation element. In the formula (1), p₀ and p₁ are integration terms, whereas z₀ and z₁ are differentiation terms. The s domain means jω. That is, phase can be compensated with the selection of a value that makes each term 0 for a certain frequency. In the following formula, K denotes gain.

$$C = \frac{K ( s + {z}_{0} ) \cdot ( s + {z}_{1} )}{( s + {p}_{0} ) \cdot ( s + {p}_{1} )} \qquad ( 1 )$$

The control formula (1) used for obtaining phase compensation illustrated in FIG. 4 is a continuous formula (analog value). Since digital control is intended here, it is necessary to discretize the analog value into a digital value. This discretization processing is called as Z-transform. The discretized control formula is shown as the following formula (2).

$${C}_{2} = \frac{{B}_{0} + {B}_{1} \cdot {z}^{- 1} + {B}_{2} \cdot {z}^{- 2}}{1 + {A}_{0} \cdot {z}^{- 1} + {A}_{1} \cdot {z}^{- 2}} \qquad ( 2 )$$

In the above formula (2), A₀ and A₁ denote constants that are obtained as a result of Z-transformation of the denominator of the formula (1), whereas B₀, B₁, and B₂ denote constants that are obtained as a result of Z-transformation of the numerator of the formula (1). The following control formula (3) can be derived from the formula (2).

duty[0]=A₀·duty[1]+A₁·duty[2]+B₀·e[0]+B₁·e[1]+B₂·e[2] (3)

In the above formula (3), duty [0] denotes a current duty value, which is applied currently. Duty [1] denotes the last duty value. Duty [2] denotes the duty value immediately before the last. In the formula (3), e[0], e[1], and e[2] denote a current deviation between an output voltage value and a target voltage value, the last deviation, and the deviation immediately before the last, respectively. That is, it is possible to calculate the current duty value on the basis of the multiplication of each value of duty and deviation by the corresponding value of a set of coefficients (A₀, A₁, B₀, B₁, B₂). It is especially important that discretization should be performed relative to the drive frequency of the DC/DC converter 1 when the set of coefficients (A₀, A₁, B₀, B₁, B₂) is calculated through discretization processing. For example, it is calculated with 4 μs when discretized at a drive frequency of 250 KHz. It is calculated with 1 μs when discretized at a drive frequency of 1 MHz. Therefore, it is necessary to set a set of coefficients (A₀, A₁, B₀, B₁, B₂) for each frequency.

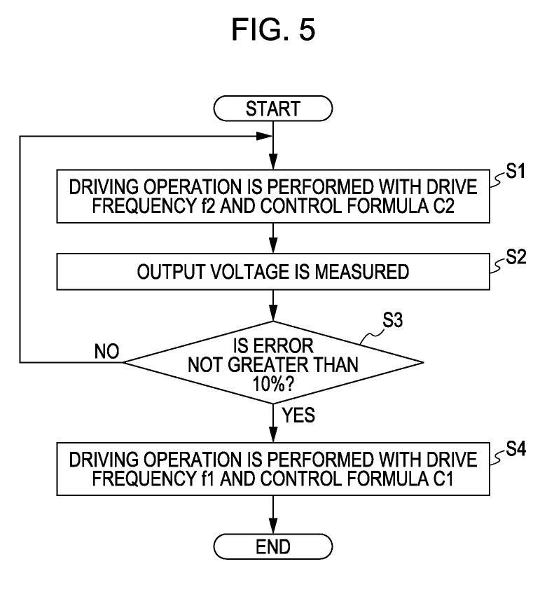

FIG. 5 is a flowchart that schematically illustrates an example of a driving method according to an exemplary embodiment of the invention. In a driving method according to the present embodiment of the invention, a drive frequency is lowered to improve circuit efficiency at the time when a deviation between a target voltage value and an output voltage value becomes equal to or smaller than a predetermined value. The driving method explained below is implemented when a drive program stored in the memory 104 is executed and when the CPU 103 controls each block in accordance with the drive program.

In a step S1, upon receiving an instruction for activating the power supply apparatus 100, the power supply apparatus 100 starts driving operation at a drive frequency f2 in order to output a target voltage value αV. In this activation operation, a set of coefficients that corresponds to the drive frequency f2 is selected among the sets of coefficients that are stored in the data table of the memory 104. The selected set of coefficients is substituted into the formula (3) to obtain a control formula (i.e., controlling expression) C2. The control formula C2 is used for phase compensation. A drive pulse of the drive frequency f2 that has been subjected to phase compensation by means of the control formula C2 corresponds to a second driving signal according to an aspect of the invention. In a step S2, an output voltage value is measured on the basis of the detection voltage Vo of the detection circuit 2. Specifically, the value is found with reference to the data table of the memory 104 in which a relationship between digital data of the detection voltage Vo and output voltage values is stored. In a step S3, an error (%) is calculated on the basis of the target voltage value αV and the output voltage value measured in the step S2. Then, it is judged whether or not the error is not greater than 10%. The error (%) is a value expressed in percentage; the output voltage value is subtracted from the target voltage value αV as a deviation; the target voltage value αV is taken as 100 to express the deviation, that is, the remaining value after subtraction, as the percentage value. The digital IC 101 functions as an arithmetic operation unit to calculate the error. If the error is not greater than 10% (S3: YES), the process proceeds to a step S4. If the error is greater than 10% (S3: NO), the process returns to the step S1. In the step S4, the drive frequency is switched over from the drive frequency f2 to a drive frequency f1, which is lower than the drive frequency f2. A set of coefficients that corresponds to the drive frequency f1 is selected among the sets of coefficients that are stored in the data table of the memory 104. The selected set of coefficients is substituted into the formula (3) to obtain a control formula C1. The control formula C1 is used for phase compensation. A drive pulse of the drive frequency f1 that has been subjected to phase compensation by means of the control formula C1 corresponds to a first driving signal according to an aspect of the invention.

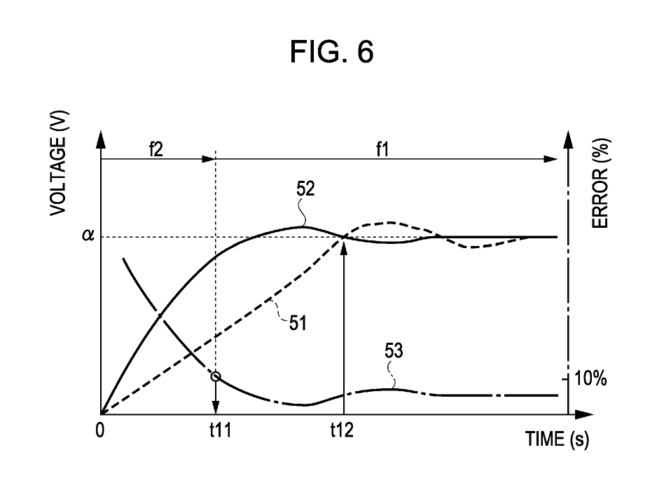

FIG. 6 is a graph that schematically illustrates a change in the level of an output voltage when a driving method of a comparative example is used and a change in the level of an output voltage when the above driving method according to the present embodiment of the invention is used, which are compared over a time series. The horizontal axis of the graph represents elapsed time (sec). The left vertical axis of the graph represents output voltage (V). The right vertical axis of the graph represents error (%). It is only the first driving signal corresponding to the drive frequency f1 that is used in a driving method of the comparative example whose output level change is shown in the graph by a curve 51. For this reason, the level of a voltage reaches the target voltage value αV at a point in time t12, which is later than a point in time t11. In contrast, in a driving method according to the present embodiment of the invention whose output level change is shown in the graph by a curve 52, the power supply apparatus 100 is activated by means of the second driving signal corresponding to the drive frequency f2 first. Thereafter, at a point in time at which the error becomes not greater than 10%, the driving signal is switched over from the second driving signal corresponding to the drive frequency f2 to the first driving signal corresponding to the drive frequency f1. In other words, the driving signal is switched over from the second driving signal corresponding to the drive frequency f2 to the first driving signal corresponding to the drive frequency f1 at the point in time t11 at which the error becomes not greater than 10%. A curve 53 shows the percentage of the error. It indicates that the error reaches 10% at the point in time t11.

For example, when the power supply apparatus 100 is used as a power source for a solid-state light source such as a laser, a light-emitting diode (LED), or the like, the input voltage supplied from the AC/DC converter (i.e., AC/DC circuit) 5 (refer to FIG. 1) is set at approximately 12V. The output voltage of the DC/DC converter 1 is set at approximately 4V. The drive frequency f1 is set at approximately 250 KHz. The drive frequency f2 is set at approximately 1 MHz. Though it depends on the rating of the solid-state light source, time taken up to the point in time t11 falls within a range from several tens of milliseconds (ms) to several seconds (s). Though an error is used as an index value in the above explanation, a deviation of an output voltage value from a target voltage value may be used. In this case, a calculated current deviation is compared with a predetermined deviation in the step S3. Even when the above method is adopted, it is possible to perform the same drive control as above. It is explained above that the drive frequency is switched over from the drive frequency f2 to the drive frequency f1 in a single step. However, the scope of the invention is not limited to the single-step switchover. That is, it may be switched over in multiple steps. For example, the drive frequency may be switched over in two steps with the first switchover at a point in time at which the error reaches 15% and the second switchover at a point in time at which the error reaches 8%. With such a modified method, it is possible to perform finer control.

As explained in detail above, the power supply apparatus 100 according to the present embodiment of the invention and a method for driving the power supply apparatus 100 produce the following advantageous effects. A control formula is stored in the memory 104. A dedicated control formula that is to be used for phase compensation can be individually set for each of a plurality of drive frequencies. Unlike a power supply apparatus of related art, which is provided with an analog phase compensation circuit that is dedicated for a single drive frequency, the power supply apparatus 100 according to the present embodiment of the invention makes it possible to switch over from one drive frequency to the other or another. In other words, since the digital IC 101 digitizes phase compensation, circuit oscillation does not occur even when the drive frequency is changed. Therefore, a driving method according to the present embodiment of the invention makes it possible to perform a drive-frequency changeover without causing any circuit oscillation. In addition, the power supply apparatus 100 with the adoption of such a driving method is provided.

As illustrated in FIG. 6, in a driving method according to the present embodiment of the invention, the second driving signal corresponding to the drive frequency f2 is used for driving upon activation. For this reason, a voltage level reaches the target voltage value αV at the point in time t11, which is earlier than the point in time t12 at which a voltage level reaches the target voltage value αV when a driving method of a comparative example is adopted. This means that a driving method according to the present embodiment of the invention is superior to a driving method of the comparative example in terms of tracking ability. The first driving signal corresponding to the drive frequency f1, which is lower than the drive frequency f2, is used for driving after the point in time t11. In other words, the first driving signal that offers greater circuit efficiency than that offered by the second driving signal is used for driving after the point in time t11. For this reason, circuit efficiency after the point in time t11 attained by a driving method according to the present embodiment of the invention is equivalent to that of a driving method of the comparative example. That is, a driving method according to the present embodiment of the invention makes it possible to obtain a target voltage quickly by performing driving operation with a driving signal having a higher drive frequency at the time of activation, and in addition, to increase circuit efficiency by switching over from the driving signal having the higher drive frequency to a driving signal having a lower drive frequency upon reaching the target voltage. Therefore, with a driving method according to the present embodiment of the invention, both excellent tracking ability and great circuit efficiency can be achieved. In addition, the power supply apparatus 100 with the adoption of such a driving method is provided. Needless to say, the foregoing embodiment is not intended to limit the scope of the invention. For example, the driving signal may be switched back to the second driving signal, which is used for driving again for a certain period of time, in a case where there is a large load variation during driving operation when the first driving signal is used. That is, the concept of the invention is applicable to a driving method that performs a drive-frequency switchover during driving operation between a relatively high drive frequency, which is used when load variation is large, and a relatively low drive frequency, which is used when load variation is small. With such a driving method, it is possible to achieve excellent tracking ability and great circuit efficiency in a compatible manner, thereby having it both ways.

### Second Embodiment

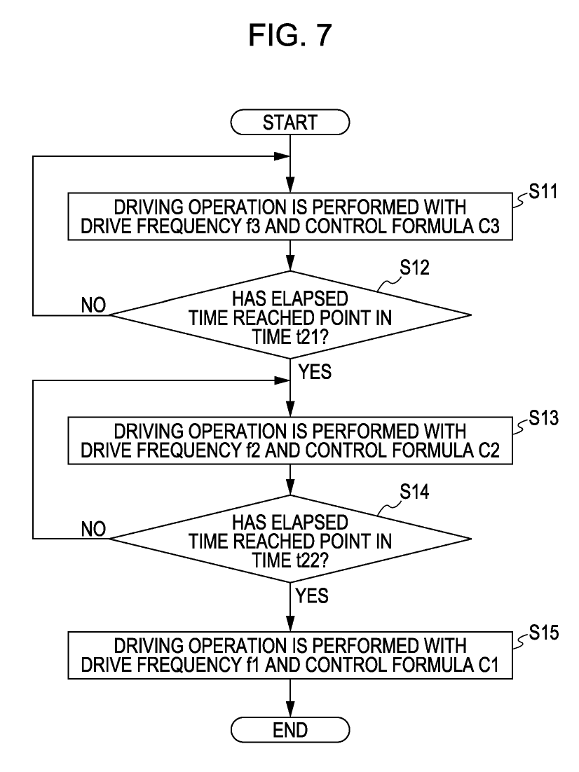

FIG. 7 is a flowchart that schematically illustrates an example of a driving method used by a power supply apparatus according to a second embodiment of the invention. A driving method used by a power supply apparatus according to the second embodiment of the invention is explained below. In the following description, the same reference numerals are consistently used for the same components as those of the power supply apparatus 100 according to the first embodiment of the invention so as to omit any redundant explanation. A power supply apparatus according to the second embodiment of the invention has the same configuration as that of the power supply apparatus 100 according to the first embodiment of the invention (refer to FIG. 1). The difference between the second embodiment of the invention and the first embodiment of the invention lies in a driving method. Specifically, in the present embodiment of the invention, a drive program that is different from that of the first embodiment of the invention, an accompanying control formula, and the like are stored in the memory 104. Drive-frequency switchover control is performed in three steps by means of the drive program. A plurality of drive programs including the drive program according to the first embodiment of the invention may be stored in the memory 104 for selection among them.

First of all, in the present embodiment of the invention, a third driving signal is used in addition to the aforementioned first driving signal and second driving signal. The drive frequency of the third driving signal, which is denoted as f3, is higher than the drive frequency f2. That is, the third driving signal has the highest drive frequency f3 whereas the first driving signal has the lowest drive frequency f1 (the drive frequency f3>the drive frequency f2>the drive frequency f1). In a step S11, upon receiving an instruction for activating the power supply apparatus 100, the power supply apparatus 100 starts driving operation at a drive frequency f3 in order to output a target voltage value αV. In addition, the CPU 103, which behaves as a drive time cumulative count unit, starts the counting (i.e., measurement) of elapsed time when triggered by the instruction for activation (i.e., command). A set of coefficients that corresponds to the drive frequency f3 is selected among the sets of coefficients that are stored in the data table of the memory 104. The selected set of coefficients is substituted into the formula (3) to obtain a control formula C3. The control formula C3 is used for phase compensation. A drive pulse of the drive frequency f3 that has been subjected to phase compensation by means of the control formula C3 corresponds to a third driving signal according to an aspect of the invention. In a step S12, it is judged whether time t21 has elapsed or not. In other words, it is judged whether elapsed time has reached the point in time t21 or not. If it is judged that elapsed time has reached the point in time t21 (S12: YES), the process proceeds to a step S13. If it is judged that elapsed time has not reached the point in time t21 yet (S12: NO), the process returns to the step S11. In the step S13, the driving signal is switched over from the third driving signal to the second driving signal. In the step S14, it is judged whether elapsed time has reached a point in time t22 or not. If it is judged that elapsed time has reached the point in time t22 (S14: YES), the process proceeds to a step S15. If it is judged that elapsed time has not reached the point in time t22 yet (S14: NO), the process returns to the step S13. In the step S15, the driving signal is switched over from the second driving signal to the first driving signal.

The point in time t21 (time t21) and the point in time t22 are pre-stored in the memory 104 as constants for the drive program. These points in time t21 and t22 are experimentally found values that can optimize tracking ability and circuit efficiency. For example, when the power supply apparatus 100 is used as a power source for a solid-state light source such as a laser, an LED, or the like, the output voltage of the DC/DC converter 1 is set at approximately 4V when the input voltage supplied from the AC/DC converter 5 (refer to FIG. 1) is set at approximately 12V. Though it depends on the rating of the solid-state light source, the time t21 is set within a range from several tens of milliseconds (ms) to several seconds (s) since activation. The point in time t22 is set at several seconds after the lapse of the time t21.

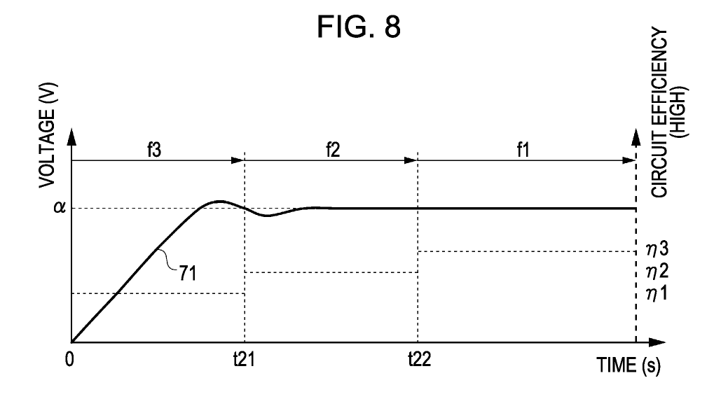

FIG. 8 is a graph that schematically illustrates a change in the level of an output voltage when a driving method according to the present embodiment of the invention is used, which is shown over a time series and corresponds to FIG. 6. The right vertical axis of the graph represents circuit efficiency. As shown by a curve 71, a response speed during a time period from the start of driving operation to the point in time t21, which is a time period in which the drive frequency f3 is used for driving, is very high. Circuit efficiency for this time period is η1. The drive frequency f2 is used during a time period from the point in time t21 to the point in time t22. A deviation during this time period is smaller than that during the time period from the start of driving operation to the point in time t21. Accordingly, the drive frequency f2, which is lower than the drive frequency f3, is enough for quickly causing an output voltage to settle at the voltage α, thereby obtaining speedy voltage-level stability. Circuit efficiency for this time period is η2. The only thing needed after the point in time t22 is to keep the stabilized voltage α. Therefore, the drive frequency f1, which is lower than the drive frequency f2, is used for driving after the point in time t22. Circuit efficiency for this time period is η3. The circuit efficiency η3 is higher than the circuit efficiency η2, which is higher than the circuit efficiency η1.

As explained in detail above, in addition to the advantageous effects of the first embodiment of the invention, a power supply apparatus according to the present embodiment of the invention and a method for driving the power supply apparatus produce the following advantageous effects. In a driving method according to the present embodiment of the invention, drive-frequency switchover control is performed in three steps according to accumulated drive time. As shown by the curve 71 in the graph, the drive frequency f3 is used for driving till the point in time t21. As a result, load-tracking ability improves. Thereafter, the drive frequencies f2 and f1 are selected sequentially depending on the magnitude of load variation, in other words, depending on the level of a deviation. Therefore, it is possible to achieve the greatest circuit efficiency with the use of the lowest drive frequency after the point in time t22. Thus, it is possible to provide a driving method that offers both excellent load-tracking ability and great circuit efficiency in a compatible manner. In addition, a power supply apparatus with the adoption of such a driving method is provided.

### First Light Source Apparatus

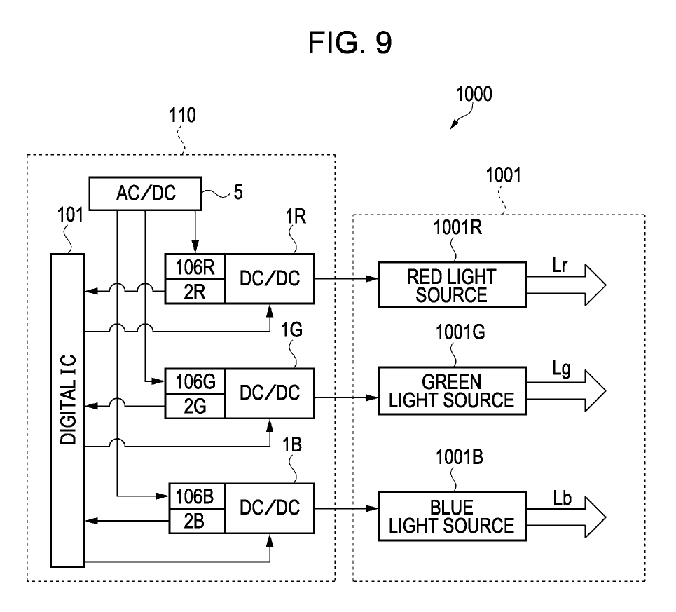

FIG. 9 is a block diagram that schematically illustrates an example of the configuration of a first light source apparatus according to an exemplary embodiment of the invention, which is equipped with a power supply apparatus according to the first embodiment of the invention. In the following description, a light source apparatus 1000 that is equipped with the power supply apparatus 100 according to the first embodiment of the invention is explained. The light source apparatus 1000 is a laser light source apparatus. Either a driving method according to the first embodiment of the invention or a driving method according to the second embodiment of the invention may be used. In the following description, the same reference numerals are consistently used for the same components as those of a power supply apparatus according to the foregoing embodiments of the invention so as to omit any redundant explanation.

The light source apparatus 1000 explained here as the first light source apparatus includes a power supply apparatus 110, a solid-state light source 1001, and the like. The configuration of the power supply apparatus 110 is modified from that of the power supply apparatus 100 according to the first embodiment of the invention. The power supply apparatus 110 includes one AC/DC circuit 5, one digital IC 101, three DC/DC converters 1R, 1G, and 1B, three detection circuits 2R, 2G, and 2B, and three gate drivers 106R, 106G, and 106B as main components. That is, the single digital IC 101 controls the driving operation of the three DC/DC converters 1R, 1G, and 1B. The solid-state light source 1001 is made up of a red light source 1001R, which emits a beam of red light Lr, a green light source 1001G, which emits a beam of green light Lg, and a blue light source 1001B, which emits a beam of blue light Lb. The solid-state light source 1001 is not limited to a laser-type light source. For example, the solid-state light source 1001 may be an LED-type light source.

As connection between the power supply apparatus 110 and the solid-state light source 1001, each of the three DC/DC converters 1R, 1G, and 1B is connected to the corresponding one of the three light sources 1001R, 1001G, and 1001B. That is, the red light source 1001R is connected as a load of the DC/DC converter 1R. The green light source 1001G is connected as a load of the DC/DC converter 1G. The blue light source 1001B is connected as a load of the DC/DC converter 1B. In order to supply a voltage that is required for operating each of the three light sources 1001R, 1001G, and 1001B, the digital IC 101 generates a driving signal that reflects a detection voltage from the corresponding one of the three detection circuits 2R, 2G, and 2B. Then, the digital IC 101 performs PWM-driving control on each of the three DC/DC converters 1R, 1G, and 1B.

As explained above, the light source apparatus 1000 according to the present embodiment of the invention produces the following advantageous effects. The light source apparatus 1000 is equipped with the power supply apparatus 110 that is capable of achieving both excellent tracking ability and great circuit efficiency. Therefore, it is possible to light each of the three primary-color light sources 1001R, 1001G, and 1001B up to a predetermined illumination level quickly. In addition, it is possible to ensure great circuit efficiency after the lighting-up thereof. The excellent tracking ability of the power supply apparatus 110 enables each of the light sources 1001R, 1001G, and 1001B to light up at a high speed at the time of activation. In addition, it can be driven for continued illumination with great circuit efficiency during stable driving operation. Thus, the light source apparatus 1000 makes it possible to achieve both excellent tracking ability at the time of lighting-up operation upon activation and great circuit efficiency after lighting-up in a compatible manner.

### Second Light Source Apparatus

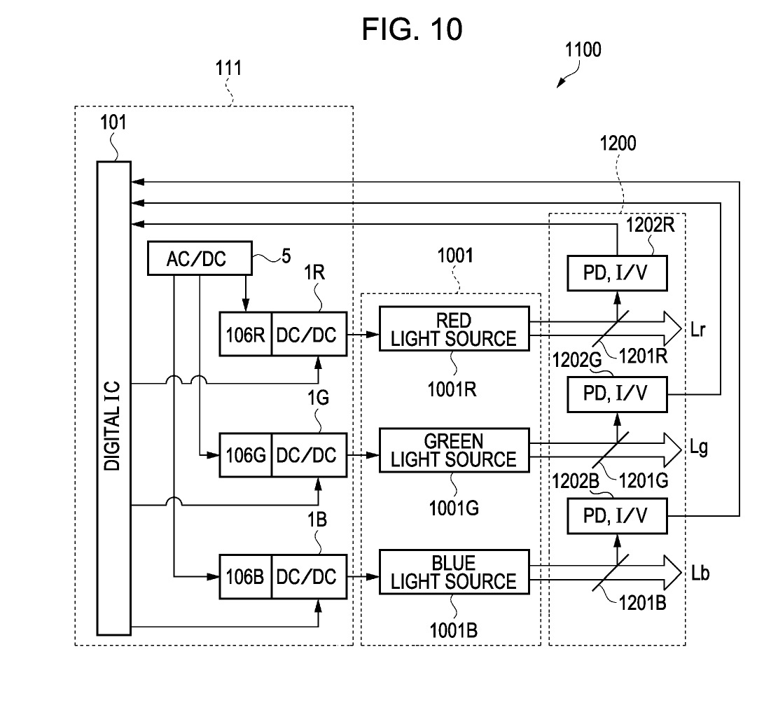

FIG. 10 is a block diagram that schematically illustrates an example of the configuration of a second light source apparatus according to an exemplary embodiment of the invention, which is equipped with a power supply apparatus according to the first embodiment of the invention. In the following description, a light source apparatus 1100 that is equipped with the power supply apparatus 100 according to the first embodiment of the invention is explained. The light source apparatus 1100 is a laser light source apparatus. Either a driving method according to the first embodiment of the invention or a driving method according to the second embodiment of the invention may be used. In the following description, the same reference numerals are consistently used for the same components as those of a power supply apparatus according to the foregoing embodiments of the invention and the first light source apparatus 1000 so as to omit any redundant explanation. Light sources are subjected to open loop control in the first light source apparatus 1000 explained above. Unlike the first light source apparatus 1000, automatic power control (APC), which is a kind of feedback control, is performed on light sources in the light source apparatus 1100 explained here as the second light source apparatus. In other words, the light source apparatus 1100 differs from the first light source apparatus 1000 (refer to FIG. 9) in that it is not provided with the detection circuit 2 (2R, 2G, and 2B). As a substitute for the function of the detection circuit 2, the light source apparatus 1100 detects the amount of light emitted by each of its light sources. Then, feedback control is performed on the basis of the detected amount of light.

The light source apparatus 1100 includes a power supply apparatus 111, the solid-state light source 1001, a light amount detection unit 1200, and the like. The configuration of the power supply apparatus 111 is different from that of the power supply apparatus 110 (refer to FIG. 9) in that the detection circuit 2 is omitted. The light amount detection unit 1200 includes half mirrors 1201R, 1201G, 1201B and detection circuits 1202R, 1202G, 1202B. Each of the half mirrors 1201R, 1201G, 1201B reflects a part of light emitted by the corresponding one of three primary-color light sources. Each of the detection circuits 1202R, 1202G, 1202B detects the amount of light reflected by the corresponding one of the half mirrors 1201R, 1201G, 1201B. For example, the half mirror 1201R reflects a part of red light Lr emitted from the red light source 1001R. The reflected light enters a photodiode PD of the detection circuit 1202R as incident light. The photodiode PD detects the amount of the incident red light as a current value. The current value is inputted into a converter I/V. The converter I/V converts the current value detected by the photodiode PD into a voltage value. The voltage value is inputted into the A/D converter 102 of the digital IC 101 (refer to FIG. 1). On the basis of a detection signal outputted from the converter I/V of the detection circuit 1202R, the digital IC 101 performs feedback control on the DC/DC converter 1R, thereby controlling the light amount of the red light source 1001R. The control explained above is called as APC (Automatic Power Control).

The APC control is performed for the green light source 1001G and the blue light source 1001B in the same way as above. As a result, it is possible to provide an image with constant amount of light to a viewer. Specifically, the half mirrors 1201G and 1201B reflect a part of green light Lg emitted from the green light source 1001G and a part of blue light Lb emitted from the blue light source 1001B, respectively. The reflected light enters the photodiodes PD of the detection circuits 1202G and 1202B as incident light, respectively. The incident light is converted into voltage values that indicate the amount of the green light and the amount of the blue light, respectively. The voltage values are inputted into the A/D converter 102 of the digital IC 101, respectively. It is explained above that the power supply apparatus 111 is not provided with the detection circuit 2. However, the configuration of the light source apparatus 1100 is not limited to such an example. For example, the light source apparatus 1100 may be provided with the detection circuit 2 in addition to the light amount detection unit 1200. In such a modified configuration, feedback control may be performed on the basis of averaged detection data, which is obtained by averaging detection signals outputted from both of them. Or, feedback control may be performed on the basis of weighted average detection data, which is obtained by weighting and averaging detection signals outputted from both of them. With such a modified configuration, it is possible to increase feedback control reliability on the basis of two detection data.

As explained above, in addition to the advantageous effects produced by the first light source apparatus 1000, the light source apparatus 1100 according to the present embodiment of the invention produces the following advantageous effects. The light source apparatus 1100 is capable of detecting the amount of light emitted by each of its light sources and then performing APC control on the basis of the detected amount of light. In addition, the light source apparatus 1100 makes it possible to achieve both excellent tracking ability at the time of lighting-up operation upon activation and great circuit efficiency after lighting-up in a compatible manner.

### Electronic Apparatus

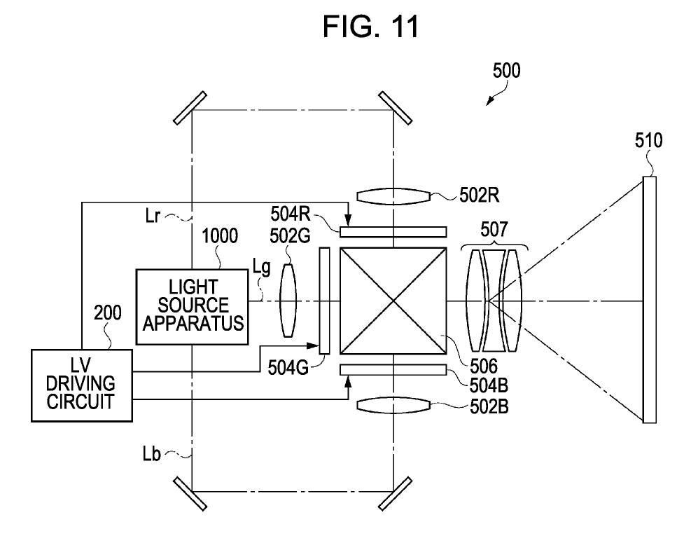

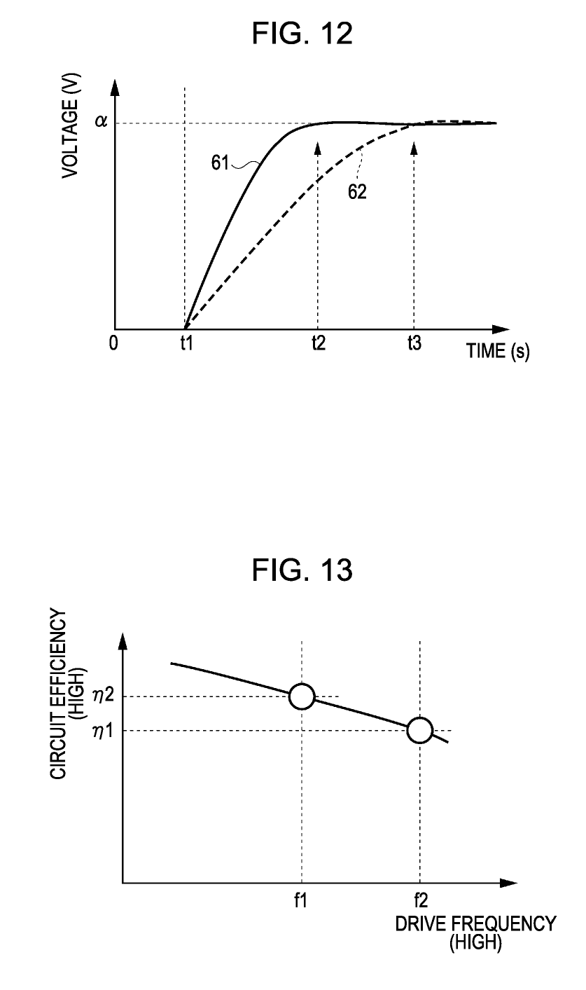

FIG. 11 is a diagram that schematically illustrates an example of the configuration of a projector according to an exemplary embodiment of the invention in which the above light source apparatus is used as a light source unit. In the following description, a projector that is equipped with either the first light source apparatus 1000 or the second light source apparatus 1100 is explained. The projector is an example of an electronic apparatus according to an aspect of the invention. In the following description, the same reference numerals are consistently used for the same components as those of a power supply apparatus and a light source apparatus according to the foregoing embodiments of the invention so as to omit any redundant explanation.

A projector 500 is equipped with either the first light source apparatus 1000 or the second light source apparatus 1100, which functions as a light source unit of the projector 500. Though the light source apparatus 1000 appears in the following description, the light source apparatus 1000 may be replaced with the light source apparatus 1100. The projector 500 includes liquid crystal light valves 504R, 504G, and 504B, a cross-dichroic prism 506, and a projection lens 507. The light source apparatus 1000 emits red light Lr, green light Lg, and blue light Lb. A light valve (LV) driving circuit 200 sends an image signal to each of the liquid crystal light valves 504R, 504G, and 504B. The liquid crystal light valves 504R, 504G, and 504B, which constitute an example of a light modulating section according to an aspect of the invention, modulate the light Lr, Lg, and Lb in accordance with the image signals, respectively. The cross-dichroic prism 506 combines the modulated beams of light outputted respectively from the liquid crystal light valves 504R, 504G, and 504B and then directs the combined light to the projection lens 507. The projection lens 507 projects an image formed by the liquid crystal light valves 504R, 504G, and 504B with the enlargement of an image size onto a screen 510.

The projector 500 further includes equalizing optical systems 502R, 502G, and 502B. Each of the equalizing optical systems 502R, 502G, and 502B is provided at the downstream side of an optical path, which is downstream as viewed from the light source apparatus 1000. The equalizing optical systems 502R, 502G, and 502B equalize the illumination distribution of the light Lr, Lg, and Lb emitted from the light source apparatus 1000, respectively. Accordingly, the liquid crystal light valves 504R, 504G, and 504B are illuminated with light having the equalized illumination distribution. For example, a hologram, a field lens, or the like can be used for the equalizing optical systems 502R, 502G, and 502B.

The three beams of light that have been modulated by the liquid crystal light valves 504R, 504G, and 504B enter the cross-dichroic prism 506 as incident beams of light. The cross-dichroic prism 506 includes four right-angle prisms that are attached to one another. A dielectric multilayer film that reflects red light and a dielectric multilayer film that reflects blue light are provided in the shape of a cross inside the cross-dichroic prism 506. These dielectric multilayer films combine the three beams of light, thereby generating light that reproduces a color image. The projection lens 507, which is a projection optical system, projects the combined light onto the screen 510. As a result, an enlarged image is displayed on the screen 510.

As explained above, the projector 500 according to the present embodiment of the invention produces the following advantageous effects. The projector 500 is equipped with either the light source apparatus 1000 or the light source apparatus 1100, which functions as the light source unit of the projector 500. Therefore, it is possible to obtain each light Lr, Lg, and Lb that has a predetermined illumination level quickly. Thus, the projector 500 can project an image speedily after activation. In addition, it is possible to ensure great circuit efficiency after the lighting-up thereof. Therefore, power consumption can be reduced. Thus, the projector 500 can achieve both speedy projection of an image after activation and low power consumption in a compatible manner.

The scope of the invention is not limited to exemplary embodiments described above. The invention may be modified, adapted, changed, or improved in a variety of modes in its actual implementation. A variation example is explained below.

### Variation Example

A variation example is explained with reference to FIG. 9. In the foregoing embodiments of the invention, it is explained that each of the red light source 1001R, the green light source 1001G, and the blue light source 1001B is connected to the corresponding one of the three DC/DC converters 1R, 1G, and 1B. However, the scope of the invention is not limited to such an exemplary configuration. For example, a single DC/DC converter may drive three light sources. Specifically, three light sources are connected in parallel to one DC/DC converter as the loads of the DC/DC converter. A switch for selecting one light source at a time is provided. The DC/DC converter supplies a driving signal to the three light sources in a time division scheme to drive the three light sources for lighting-up operation. With the above configuration, it is possible to drive the three light sources for lighting with the use of the single DC/DC converter. Therefore, the configuration of a light source apparatus is simplified.

The entire disclosure of Japanese Patent Application No. 2009-040322, filed Feb. 24, 2009 is expressly incorporated by reference herein.

What is claimed is:

1. A power supply apparatus comprising:
a direct current power source;
a chopper circuit into which a voltage outputted from the direct current power source is inputted;
a detection circuit that detects a value of a voltage corresponds to an output voltage value of the chopper circuit, which is hereinafter referred to as output voltage value; and
a digital signal processor that generates a driving signal that is used for driving the chopper circuit, the digital signal processor including
a storing section that stores a target voltage value, a control formula that is used for generating the driving signal, and a plurality of sets of coefficients, and
an arithmetic operating section that calculates a deviation of the output voltage value from the target voltage value,
wherein each of the plurality of sets of coefficients corresponds to one of a plurality of frequencies that are different from each other or one another,
the digital signal processor determines a drive frequency of the driving signal on the basis of the deviation, and
the digital signal processor inputs a set of coefficients that corresponds to the drive frequency selectively among the plurality of sets of coefficients to generate the driving signal.

2. The power supply apparatus according to claim 1, wherein the chopper circuit is driven by means of the driving signal that has a first drive frequency when the deviation is larger than a predetermined value, and;
the chopper circuit is driven by means of the driving signal that has a second drive frequency, which is lower than the first drive frequency, when the deviation has become equal to or smaller than the predetermined value.

3. The power supply apparatus according to claim 1, further comprising a drive time cumulative counting section that counts elapsed time that is measured from a point in time at which operation of the direct current power source is started,
wherein the chopper circuit is driven by means of the driving signal that has a first drive frequency upon the start of the operation of the direct current power source, and;
the chopper circuit is driven by means of the driving signal that has a second drive frequency, which is lower than the first drive frequency, after the elapsed time has reached a predetermined point in time.

4. The power supply apparatus according to claim 1, wherein the detection circuit is connected to output terminal of the chopper circuit, that detects a value of a voltage value outputted from the output terminal of the chopper circuit corresponds to the output voltage value.

5. A light source apparatus comprising:
the power supply apparatus according claim 1; and
a solid-state light source that emits light,
wherein the power supply apparatus controls a light ON/OFF state of the solid-state light source.

6. The light source apparatus according to claim 5, wherein the detection circuit comprising:
a light amount detecting section that detects the amount of light emitted by the solid-state light source as a current value; and
a converting section that converts the current value, which indicates the amount of light, into a voltage value that corresponds to the output voltage value,
wherein the arithmetic operating section calculates the deviation with the use of the converted voltage value.

7. An electronic apparatus comprising:
the light source apparatus according to claim 5; and
a light modulating section that modulates light emitted by the light source apparatus into modulated light in accordance with an image signal.

8. A method for driving a power supply apparatus that is provided with a chopper circuit into which a voltage outputted from a direct current power source is inputted, a detection circuit that detects a value of a voltage outputted from the chopper circuit, which is hereinafter referred to as output voltage value, and a digital signal processor that generates a driving signal that is used for driving the chopper circuit, the digital signal processor including a storing section that stores a target voltage value, a control formula that is used for generating the driving signal, and a plurality of sets of coefficients, each set of which corresponds to one of a plurality of drive frequencies that are different from each other or one another, the driving method comprising:
detecting the output voltage value and calculating a deviation of the output voltage value from the target voltage value;
comparing the calculated deviation with a predetermined deviation; and
switching the driving signal from a current driving signal to another driving signal whose drive frequency is lower than that of the current driving signal when the calculated deviation is not larger than the predetermined deviation.

9. A light source apparatus comprising:
the power supply apparatus according to claim 2; and
a solid-state light source that emits light,
wherein the power supply apparatus controls a light ON/OFF state of the solid-state light source.

10. A light source apparatus comprising:
the power supply apparatus according to claim 3; and
a solid-state light source that emits light,
wherein the power supply apparatus controls a light ON/OFF state of the solid-state light source.
